(19) United States
(12) Patent Application Publication
(10) Pub. No.: US 2016/0334339 A1
(43) Pub. Date: Nov. 17, 2016

(54) SENSOR PLATFORM AND METHOD OF USE

(71) Applicant: THE BOARD OF REGENTS, THE UNIVERSITY OF TEXAS SYSTEM, Austin, TX (US)

(72) Inventor: Purnendu K Dasgupta, Arlington, TX (US)

(21) Appl. No.: 15/110,723

(22) PCT Filed: Jan. 9, 2015
(86) PCT No.: PCT/US15/10774

§ 371 Date: Jul. 8, 2016

Related U.S. Application Data
(60) Provisional application No. 61/925,309, filed on Jan. 9, 2014.

(51) Int. Cl. G01N 21/78

(52) U.S. Cl. CPC G01N 21/783; G01N 2021/773

(57) ABSTRACT

A sensor platform for analyzing an analyte with a predetermined reagent is presented. The sensor platform has a housing defining an interior chamber configured to hold the analyte. A porous tube defining an inner lumen extends through the chamber. The porous tube absorbs the analyte at a predetermined rate. A sensor is coupled to an end of the porous tube and is configured to sense changes in the material positioned in the inner lumen of the tube as the reagent reacts with the absorbed analyte.

The invention that is the subject of this application was made with U.S. government support under A1064368 and NS058030 awarded by the National Institutes of Health. The U.S. government has certain rights in this invention.

### FIELD OF THE INVENTION

This invention relates generally to platforms for analyzing volatile analytes, and more particularly to devices and methods for analyzing volatile analytes using a platform that can be inexpensive to produce and robust enough for field use.

### BACKGROUND OF THE INVENTION

Field-usable platforms are needed for many analyses including for agricultural and environmental analysis. Such chemistries are known but the conventional platforms have not been inexpensive and/or need to be conducted in a laboratory. Presently, gas chromatography (GC) with mass spectrometric, nitrogen selective or electron capture detection is most commonly used. However, with many analyses, the analyte cannot be directly injected, sample manipulation is slow and the GC methods are not presently field-usable. Other methods have also been used for analyses but none of these methods are inexpensive and field-usable with a limited number of steps. What is needed then is a robust platform for analyses that can be produced inexpensively and can reduce the steps required to achieve the desired results.

### SUMMARY

Presented herein is a platform for analyzing volatile analytes. Many analytes of interest are volatile or can be selectively converted into a volatile form. Such volatile gases can often be made to undergo chromogenic reactions with a specific reagent.

In one aspect, the platform comprises a housing defining an interior chamber and a tube positioned in the chamber. Optionally, a sample container can be positioned therein the chamber of the housing. A plurality of ports can be defined in the housing to provide access to the chamber. For example, a first port can be defined in the housing to provide an inlet to the chamber for a reagent or an analyte and a second port can be defined in the housing to provide an outlet from the chamber.

The tube can extend from the first port of the housing to the second port. In one aspect, the tube has an inner lumen such that material inserted into the first port can pass through the lumen towards the second port. In another aspect, the tube can be a porous tube configured to allow a predetermined material to pass through an outer wall of the tube and into or out of the inner lumen at a predetermined rate. For example, the tube can be a porous polypropylene membrane tube (PPMT).

In another aspect, the platform can further comprise at least one sensor configured to sense a physical element and at least one source configured to provide a physical element that can be sensed. For example, the source can be a source of light such as an LED and the like, and the sensor can be an optical sensor configured to convert light sensed to an electrical signal.

In use, the source can be positioned in the first port and coupled to a first end of the tube. The sensor can be positioned in the second port and coupled to a second end of the tube. A volatile analyte positioned in the chamber can pass through the walls of the porous tube and can react with a reagent positioned in the inner lumen of the tube. Changes in the absorbency of the materials in the lumen can be sensed by the sensor and sent to a processor for quantitation.

Related methods of operation are also provided. Other apparatuses, methods, systems, features, and advantages of the sensor platform and the method of its use will be or become apparent to one with skill in the art upon examination of the following figures and detailed description. It is intended that all such additional apparatuses, methods, systems, features, and advantages be included within this description, be within the scope of the sensor platform and the method of its use, and be protected by the accompanying claims.

### DESCRIPTION OF THE FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is a schematic view of an aspect of a sensor platform of the present application showing a housing, a sensor, a source and a tube;

FIG. 2 is a schematic view of an aspect of a sensor platform of the present application;

FIGS. 3A-3D are photographs of the sensor platform, a source of light and a portion of a sensor, according to one aspect;

FIG. 4 illustrates a portable cyanide sensor according to one embodiment;

FIG. 5 illustrates LEDs used in the portable cyanide sensor of FIG. 4 according to one embodiment;

FIG. 6 illustrates continuous detection of 2 μM of cyanide spiked bovine blood samples (replicate samples) with the portable cyanide sensor of FIG. 4;

FIG. 7 illustrates the response calculation curve of bovine blood samples measured with the portable cyanide sensor of FIG. 4;

FIG. 8 illustrates the continuous detection of 2 μM of cyanide spiked water samples with the portable cyanide sensor of FIG. 4;

FIG. 9 illustrates the response curve of water samples measured with the portable cyanide sensor of FIG. 4;

FIG. 10 illustrates a porous-membrane-based analyzer according to one embodiment;

FIG. 11 illustrates measurement of breath cyanide in a non-smoking subject; and

FIG. 12 illustrates a porous-membrane-based device in more detail according to one embodiment.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “sensor” includes aspects having two or more sensors unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

Presented herein is a platform for analysis of at least one volatile analyte (or analyte that can be selectively converted into a volatile form) such as cyanide, ammonia, arsenic, sulfite, sulfide, nitrate (reduced to ammonia), nitrite, hydrazine, hypochlorite (and other species capable of liberating chlorine), iodide and bromide (through formation of iodine and bromine) and the like. Changes to the analyte and/or a reagent after reacting can be measured by a sensor. In one aspect, the platform can be a disposable platform. In another aspect, the platform can be a reusable platform. In still another aspect, the platform can be an inexpensive platform. Optionally, in a further aspect, the platform can be a disposable, reusable and/or inexpensive platform for analysis of at least one analyte of interest.

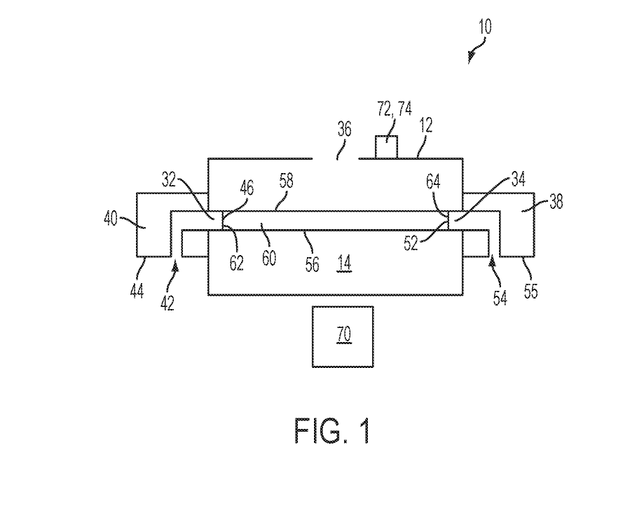

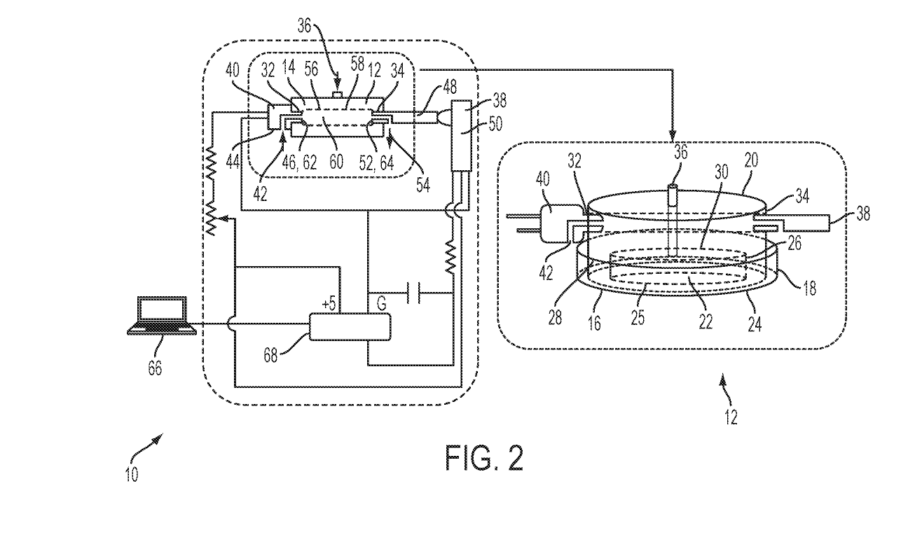

With reference to FIGS. 1 and 2, the platform 10 can comprise a housing 12. According to one aspect, the housing can be formed from an inert metal such as 316 stainless steel, titanium and the like, a polymeric material such as nylon and the like, glass and/or ceramic materials. In another aspect, the housing 12 can define a chamber 14 configured to contain at least a portion of the analyte therein. For example, the housing can comprise a bottom 16, at least one sidewall 18 extending from the bottom, and a sealing cover 20, such that when the cover is placed on the bottom, the chamber is defined therebetween. In one aspect, the bottom can be a Petri dish bottom. The Petri dish bottom and/or cover can have an inner diameter of between about 10 mm and 100 mm, between about 40 mm and 60 mm, or about 50 mm, according to various aspects. In other aspects, the height of the housing can be between about 2 mm and 100 mm, about 5 mm and 50 mm, about 10 mm and 20 mm, or about 13 mm.

Optionally, a sample container 22 can be positioned therein the chamber 14 of the housing 12. In one aspect, the sample container can be affixed to a bottom surface 24 of the housing. In a further aspect, the sample container 22 can be affixed concentrically therein the chamber 14 such that a longitudinal axis of the bottom 16 and a longitudinal axis of the sample container are coaxially aligned. In yet another aspect, the sample container 22 can comprise a bottom 25, such as for example and without limitation a Petri dish bottom, and at least one sidewall 26 extending therefrom the bottom. The sample container can have an inner diameter of between about 10 mm and 100 mm, between about 20 mm and 40 mm, or about 30 mm, according to various aspects. In other aspects, the height of the sample container 22 can be between about 1 mm and 50 mm, about 2 mm and 30 mm, about 10 mm and 20 mm, or about 13 mm. In one aspect, when the housing 12 comprises the Petri dish bottom 16 and the sealing cover 20, the sample container can be sized and positioned therein the bottom such that when the cover is placed over the Petri dish bottom 16, the cover 20 seals both the sample container 22 and the bottom. That is, in this aspect, an upper edge 28 of the sidewall 18 of the bottom 16 and an upper edge 30 of the sidewall 26 of the sample container can be substantially coplanar. Alternatively, in another aspect, when the housing 12 comprises the Petri dish bottom 16 and the sealing cover 20, the sample container 22 can be positioned therein the bottom such that when the cover is placed over the bottom, the cover 20 seals only the bottom 16. That is, in this aspect, the upper edge 28 of the sidewall 18 of the bottom can be axially spaced from the upper edge 30 of the sidewall 26 of the sample container.

In another aspect, a plurality of ports can be defined in the housing 12 to provide access to the chamber 14. For example, a first port 32 can be defined in the housing to provide an inlet to the chamber for a chemical such as a reagent or an analyte. In another example, a second port 34 can be defined in the housing 12 to provide an outlet from the chamber 14, and a third port 36 can be defined in the housing to provide an inlet to the chamber for a chemical such as a reagent or an analyte. It is of course contemplated that four, five or more than five ports can be defined in the housing. It is also contemplated that multiple ports can be provided and only those used in a given application can be opened for use; other ports can remain capped.

The platform 10 can further comprise at least one sensor 38 and at least one source 40, according to one aspect. As can be appreciated, the source can be any source capable of providing a physical element that can be sensed. For example, the source 40 can be a source of light (visible, ultraviolet or infrared), a source of electricity (potential or current) and the like. If the source is a source of light, such as an LED, the LED can be, for example and without limitation, a 583 nm light emitting diode such as a model 516-1336-ND LED distributed by the Digi-Key Corp. (digikey.com). In one aspect, a source passageway 42 can be defined in a portion of the source 40. In this aspect, the source passageway can extend from a side 44 and/or end of the source to a terminal end 46 of the source 40 such that a fluid entering the source passageway through the side of the source can travel through at least a portion of the source and exit the source through the terminal end. In another aspect, the source passageway 42 can be substantially linear, substantially L-shaped and the like.

The sensor 38 can be any sensor capable of sensing a physical element. For example, the sensor can be a sensor 38 such as an optical sensor, a conductivity sensor, a potential sensor, or a current sensor. For an optical sensor, it may be configured to measure the same wavelength of light as the source (absorbance, reflectance or turbidity measurement) or a different wavelength (fluorescence or Raman scattering measurement). It is contemplated that the sensor can comprise other types of sensors as well. If the sensor 38 is an optical sensor, in one aspect, the sensor can comprise an optical fiber 48 and a photodiode 50. In this aspect, the optical fiber and the photodiode can be coupled together such that light entering a distal end 52 of the sensor can be sensed by the photodiode 50. For example and without limitation, the photodiode can be a model TSL257 light to voltage converter manufactured by Texas Advanced Optical Systems Inc. (taosinc.com). The optical fiber 48 can be, for example and without limitation, a 2 mm inner diameter acrylic optical fiber. In one aspect, a sensor passageway 54 can be defined in a portion of the sensor 38. In this aspect, the sensor passageway can extend from a side 55 and/or end of the sensor to the distal end 52 such that a fluid entering the sensor passageway through the distal end of the sensor can travel through at least a portion of the sensor 38 and exit the sensor through the side. In another aspect, the sensor passageway 54 can be substantially linear, substantially L-shaped and the like.

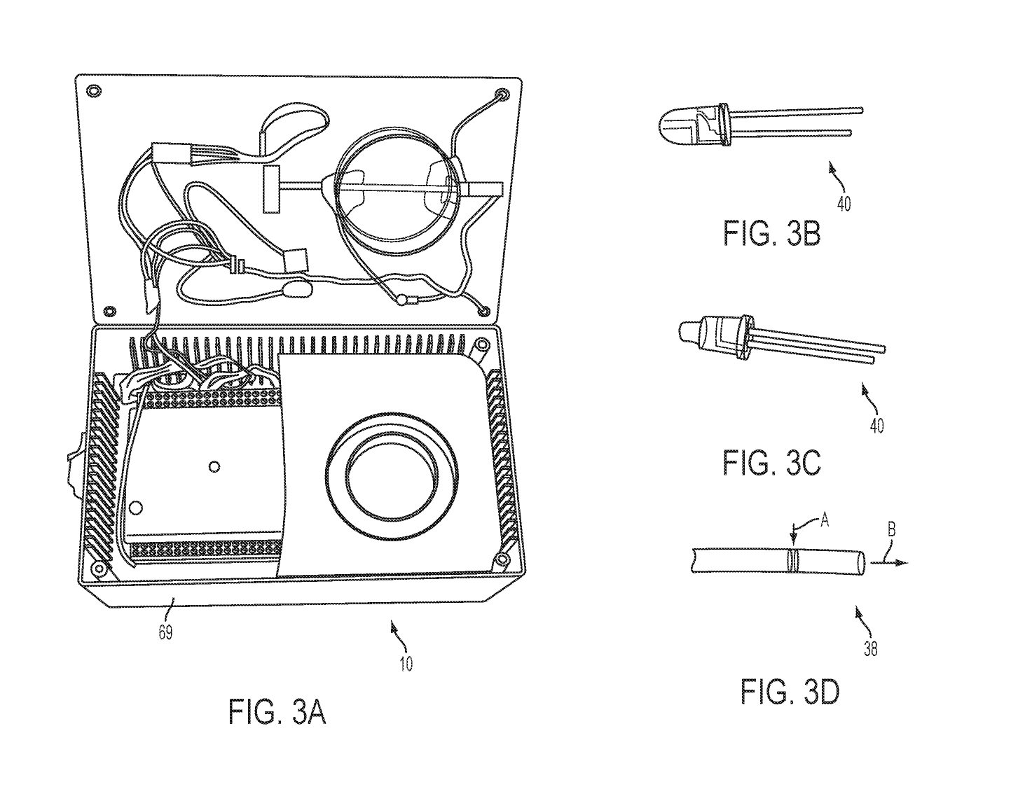

In addition to providing an inlet and/or an outlet to the chamber 14 for chemicals such as a reagent and an analyte, at least one of the first port 32, the second port 34 and the third port 36 of the housing 12 can be configured to provide access to the chamber for the at least one sensor 38 and/or the at least one source 40. That is, at least a portion of the at least one sensor and/or the at least one source can be inserted through a port of the housing and into the chamber 14. For example, at least a portion of the terminal end 46 of the source can be sized and shaped to be inserted into the first port 32 of the housing 12. As can be seen in FIG. 3C, at least a portion of the terminal end of the source (and the sensor, though not shown) can be machined down to provide a friction fit between the source 40 and a port. In another example, at least a portion of the distal end 52 of the sensor 38 can be sized and shaped to be inserted into the second port 34 of the housing.

In one aspect, the platform 10 can further comprise a means for placing the first port 32 in communication with the second port 34 and/or the third port 36. In another aspect, a tube 56 having an outer wall 58 and an inner lumen 60 can place the first port in communication with the second port and/or the third port. Optionally, the tube 56 can place the source 40 in communication with the sensor 38. In yet another aspect, the outer wall of the tube can be positioned a predetermined distance from the bottom surface 25 of the sample container 22 and/or the bottom surface 24 of the housing 12. For example, the outer wall 58 of the tube 56 can be positioned between about 1 mm and 50 mm, about 2 mm and 30 mm, about 3 mm and 20 mm, about 4 mm and 10 mm or about 5 mm away from the bottom surface 25 of the sample container 22 and/or the bottom surface of the housing 12. In one aspect, the distance between the outer wall of the tube and a liquid level formed in the chamber 14 (described more fully below) can be minimized to speed response time.

In one aspect, a first end 62 of the tube 56 can be coupled to the first port 32, and a second end 64 of the tube 56 can be coupled to the second port 34 or the third port 36 of the housing. Optionally, the first end of the tube can be positioned in or adjacent to the first port and can be coupled to the sensor 38 or the source 40. Similarly, the second end of the tube can be positioned in or adjacent to the second or third port and can be coupled to the sensor or the source. For example, at least a portion of the first end 62 of the tube 56 can be positioned in or adjacent to the first port 32 and can be coupled to the terminal end 46 of the source 40, and at least a portion of the second end 64 of the tube can be positioned in or adjacent to the second port 34 and can be coupled to the distal end 52 of the sensor 38. When so coupled, the source passageway 42, the inner lumen 60, and the sensor passageway 54 can be in fluid communication. In another aspect, the first end 62 of the tube 56 and/or the second end 64 of the tube can extend through at least one of the ports to outside of the housing.

In one aspect, at least a portion of the tube 56 can be a porous tube configured to allow a predetermined material to pass through the outer wall 58 of the tube and into or out of the inner lumen 60 at a predetermined rate. The tube can be a porous polypropylene membrane tube (“PPMT”) such as, for example and without limitation, an Accurel brand tube distributed by Membrana (www.membrana.de). The tube can also be a tube that is porous on a molecular scale thus providing high permeability to gases, such as, for example Teflon AF manufactured by DuPont http://www2.dupont.com/Teflon_Industrial/en_US/assets/downloads/h44587.pdf. In another aspect, a portion of the tube 56 can be porous, and at least one portion of the tube can be impervious. For example, a central portion of the tube 56 can be an active portion that is porous, and the first end 62 and/or the second end 64 of the tube can be impervious.

In another aspect, the tube 56 can have a predetermined length and can serve as a relatively long path porous cell. The tube 56 can have a length of between about 10 mm and 100 mm, between about 40 mm and 60 mm, or about 50 mm, according to various aspects, though other lengths are contemplated such that the tube can extend to the desired ports of the housing 12. The tube can have an inner lumen 60 diameter of less than about 1 mm, about 1 mm, about 2 mm, about 3 mm, about 4 mm, or greater than about 4 mm. In one aspect, the diameter of the inner lumen can be selected to minimize preconcentration of material in the tube 56, while maximizing source throughput (reducing noise) through the tube.

The tube 56 can be an elongate tube that is substantially straight, according to one aspect. Optionally, in another aspect, the tube can be L-shaped, T-shaped and the like such that at least a first segment of the tube is substantially perpendicular to a second segment. In this aspect, at least a portion of the first end 62 of the tube can be coupled to the terminal end 46 of the source 40, and at least a portion of the second end 64 of the tube can be coupled to the distal end 52 of the sensor 38 that is at an acute or right angle relative to the first end. In another aspect, a portion of the tube 56 that is porous can be at an acute or right angle relative to at least one portion of the tube that is impervious. For example, if the sensor 38 is configured to sense fluorescence or scattering, the sensor can be positioned adjacent to an impervious portion of the tube and substantially perpendicular to a porous portion of the tube.

The platform 10 can be coupled to a processor 66 configured to power at least one of the source 40 and the sensor 38, and to acquire and analyze the data sensed by the sensor. For example, power supply lines from at least one of the source 40 and the sensor 38 can be coupled, directly or indirectly, to the processor. Optionally, a data acquisition board 68 (“DAQ”) can be provided to acquire data sensed by the sensor and to relay that data to the processor. The data acquisition board can be a 14-bit USB-based data acquisition board such as, for example and without limitation, a model USB-1408FS produced by the Measurement Computing Corporation (www.mccdaq.com).

In one aspect, the platform 10 can further comprise a black box 69, as shown in FIG. 3A. In this aspect, the housing 12, the source 40 and the sensor 38 can be positioned in the black box to eliminate any external sources of light and/or other interference. That is, when positioned in the box, the physical quantity sensed by the sensor can be produced only by the source. In another aspect, at least a portion of the platform, such as the sealing cover 20 can be coupled to a lid of the box, so that when the black box is closed, the sealing cover seals the chamber 14 of the housing.

In one aspect, to speed response times and/or analyte transfer rates, the platform 10 can further comprise a heater 70 positioned adjacent to a portion of the chamber 14 configured to heat the contents of the chamber a predetermined amount. For example, the heater can be positioned under the sample container 22. In another aspect, to speed response times and/or analyte transfer rates, the platform can further comprise a buzzer 72 and/or vibrator 74 positioned adjacent to a portion of the chamber 14. Optionally, the platform can comprise a heater, a buzzer and/or a vibrator.

To assemble the platform 10 of the present application, in one aspect, at least a portion of the terminal end 46 of the source 40 can be inserted through the first port 32 and into the chamber 14 of the housing 12. The first end 62 of the tube 56 can be push fit onto the terminal end of the source such that the source passageway 42 is in fluid communication with the inner lumen 60 of the tube. In another aspect, at least a portion of the distal end 52 of the sensor 38 can be inserted through the second port 34 and into the chamber of the housing 12. The second end 64 of the tube can be push fit onto the distal end of the sensor such that the sensor passageway 54 is in fluid communication with the inner lumen 60 of the tube 56. The sensor 38 and the source 40 can be coupled, directly or indirectly, to the processor 66. Resistors, capacitors and the like, as known in the art, can be used to complete the electrical coupling.

In use, as described more fully below, a sample to be analyzed can be placed in the sample container 22 and the sealing cover 20 can be placed over the housing 12 to seal the sample in the sample container. A first material (such as a reagent and the like) can be inserted into the source passageway 42 through the first port 32 of the housing 12 and into the inner lumen 60 of the tube 56. The source 40 and sensor 38 can be activated to get an initial sensed measurement of the first material in the tube. For example, if the source is an LED, the sensor can measure the amount of light absorbed by the first material. A second material (such as a reagent and the like) can be inserted through the third port 36 into the sample container in the housing 12. In one aspect, at least a portion of the second material can react with the sample to create a third material. In another aspect, at least a portion of the third material can be absorbed by the porous tube 56 and can be captured by the first material in the lumen 60 of the tube. Upon waiting a predetermined amount of time, the sensor 38 can then compare the initial sensed measurement to the current sensed measurement to detect a change in the material positioned in the inner lumen from the initial sensed measurement. That is, the amount or concentration of the sample to be analyzed can be determined based on the amount of measured absorbance by the sensor. For example, if the source is an LED, the sensor can detect an increase or decrease in optical absorbency after the third material has been captured by the first material in the tube. Changes in the optical absorbency of the materials in the lumen can be sensed by the sensor and sent to the processor 66 for analysis. If the source is one providing electricity, the sensor can detect an increase or decrease in conductivity or electrochemical redox properties after the third material has been captured by the first material in the tube. After use, the platform 10 can be emptied and washed for reuse, or simply disposed of.

Optionally, any number of materials can be inserted into the housing 12 through the first port 32 and/or the third port 36 of the housing. For example, a fourth material, fifth material, sixth material or more can be used to isolate the desired compound. In one aspect, alternatively, only one material need be inserted into the housing. For example, a sample to be analyzed can be placed in the sample container 22 and the sealing cover 20 can be placed over the housing 12 to seal the sample in the sample container. A first material (such as a reagent and the like) can be inserted into the source passageway 42 through the first port 32 of the housing 12 and into the inner lumen 60 of the tube 56. In this aspect, at least a portion of the sample material can be absorbed by the porous tube and the sensor can detect an increase or decrease in optical absorbency or an increase or decrease in conductivity or electrochemical redox properties of the material in the tube. That is, the amount or concentration of the sample to be analyzed can be determined based on the amount of measured absorbance, conductivity and/or electrochemical redox properties sensed by the sensor.

In one aspect, the platform 10 can further comprise a reagent positioned in the chamber 14 of the housing 12 prior to use by a user of the platform. That is, the platform can further comprise any of the first, second, third or more materials pre-loaded into the chamber. For example, the reagent can be a solid reagent such as an acid, base, reducing or oxidizing agent and the like positioned in or affixed to a portion of the sample container 22. The reagent can be positioned in the chamber 14 during manufacturing of the platform, or at any time prior to use of the platform 10. In this aspect, in use, the sample to be analyzed can be introduced into the housing 12. At least a portion of the sample can react with the pre-loaded reagent to form a material that can pass through the porous tube 56 and the sensor 38 can detect an increase or decrease in optical absorbency or an increase or decrease in conductivity or electrochemical redox properties in the tube.

In one aspect, the platform 10 of the present application can be used as an inexpensive, portable cyanide sensor, described more fully below. In this aspect, the first material can be OH(CN)Cbi⁻, the second material can be H₃PO₄, and the third material can be HCN.

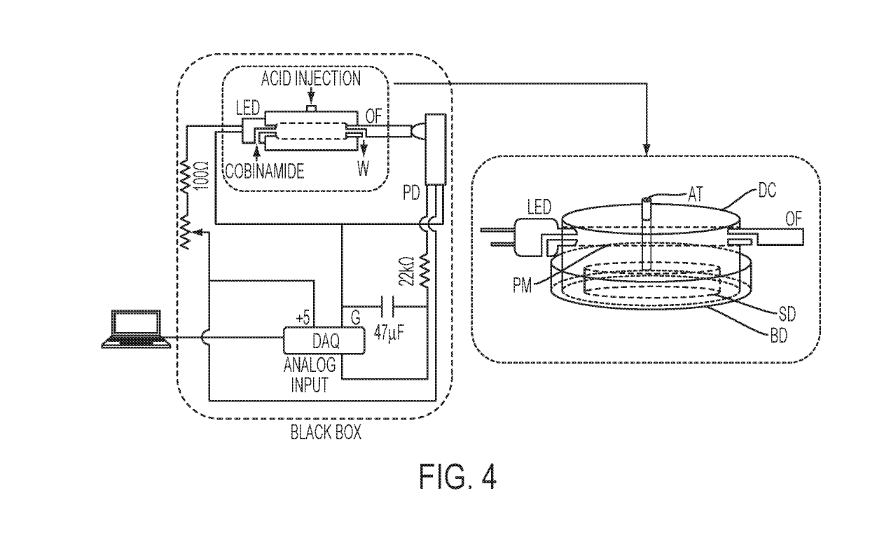

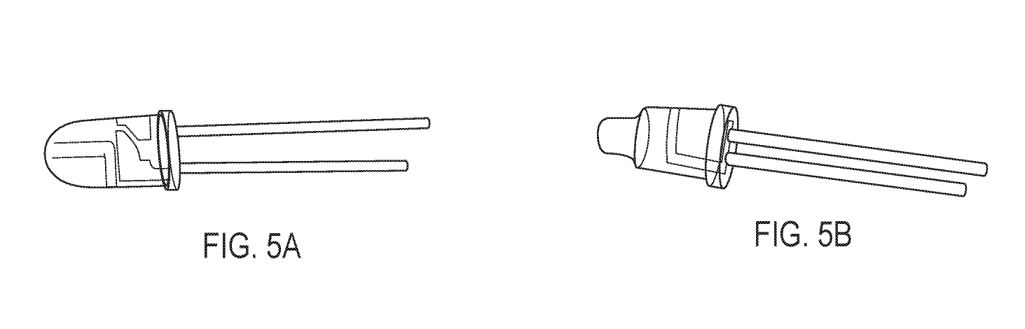

FIG. 4 illustrates a portable cyanide sensor. The disposable portion of the device has an outer Petri-dish. The top portion of this dish (35 mm diameter) can hold a porous membrane (PM) horizontally strung across it. The membrane is a porous polypropylene membrane tube (PPMT) of 1.8 mm inner diameter. The flexibility of the PPMT allows it to fit tightly to the LED and the optical fiber. The membrane terminates in a 585 nm light emitting diode (LED) with a liquid outlet. A channel can be drilled at a right angle through the optical path of the LED and the top of the LED is ground. The left image of FIG. 5 is before the machining and the right image is the LED after machining. The LED is attached in series with a 100 Ω resistor and a potential meter to protect and control the LED's light intensity. The other end of the PPMT connects to an acrylic optical fiber (OF) (2 mm inner diameter) connected to a photodiode and signal processing system. A channel was also drilled into the optical fiber at a right angle. Thus, the cobinamide solution could come into the PPMT from the LED right angle channel and exits to waste through the optical fiber right angle channel with no leakage. A TSL257 (www.taosinc.com) photodiode was connected as a detector to the end of the optical fiber opposite the PPMT. The detector output data were acquired with a 14-bit USB based data acquisition board USB-1408FS available from Measurement Computing using a ls RC filter. (22Ω resistor and 47 μF capacitor).

The LED, PPMT and optical fiber were fixed on a petri dish of 50 mm inner diameter acting as detection cell (DC). Under the detection cell was a petri dish of 54 mm inner diameter (the “bottom” dish or BD). A smaller (i.d.=30 mm) petri-dish cover was put in the bottom dish under the detection cell as sample dish (SD). Thus, the sample put into the sample dish does not run into an undefined area of the bottom dish. On the center of detection cell, a hole is drilled for a PTFE tube (AT) to introduce acid into the sample dish. The acid can be a solid strong acid for facile packaging. Just before use, the seal on a syringe containing cobinamide solution is broken and cobinamide is introduced into the porous membrane tube. One mL of blood or other liquid sample is then injected through the top and the syringe left in place so the seal is maintained. The evolved HCN is absorbed by the cobinamide in the porous membrane tube that also functions as an optical cell. Low to sub-micromolar level cyanide measurement in blood is possible in a few minutes.

All chemicals used were at least analytical-reagent grade and 18.2 MΩ cm Milli-Q water available from Millipore was used throughout. Pure cobinamide was produced by acid hydrolysis of cobalamin (available from Sigma-Aldrich) following Broderick et al (J Biol. Chem., 2005, 280, 8678-8685). 0.02 mM cobinamide solution in 0.1 M borate buffer solution (pH=10.0, prepared by dissolving sodium borate (Na₂B₄O₇10H2O, E.M. Science, CAS 1303-96-4) in Milli-Q water and adjusted to pH 10.00 with 2 M NaOH by using a pH meter (ALTEX Φ71, Beckman)) was prepared daily. The stock cyanide solution was prepared by dissolving KCN in 1 mM NaOH and stored refrigerated. Defibrinated bovine/calf blood (Code: R100-0050, www.rockland-inc.com) was used as the blank blood sample and spiked with cyanide for experimental optimization and performance calculation. Rabbit blood samples were obtained from ongoing studies conducted at the University of California, Irvine, according to NIH Guidelines for the Care and Use of Laboratory Animals, and approved by the Institutional Animal Care and Use Committee.

Prior to beginning the experiment, the LED is turned off and the black box is closed and the DAQ opened to record the dark current signal for about 200 seconds, the average of these signals is determined as I_{d}. The black box cover was opened and 1 mL of blood sample was injected into the sample dish. The sample dish was placed into the bottom dish. The sample dish is shielded from the detection cell, which is fixed on the black box cover. The porous polypropylene tube (PP tube) is filled with the cobinamide solution with the black box closed. After that, the DAQ was opened to record the signal, I₀, for 60 seconds. The acid is injected from the top of the black box into the system to release the cyanide from sample. The cyanide was captured by the cobinamide in the PPMT and thus the cobinamide solution changed color, which caused a signal, Iₜ, which was recorded by the DAQ. Signals are recorded for at least 160 seconds. After signal recordation, the black box was opened to release the remaining cyanide in the detection cell and change another sample dish for the next running.

Refreshing the cobinamide in the PPMT induces a slight fluctuation in the signal and thus I₀ was for time 50-60 seconds. To eliminate dark current influence I_{d} was subtracted from both I₀ and Iₜ. Absorbance, A, was determined by the following formula, A=log ((I₀-I_{d})/(Iₜ-I_{d})).

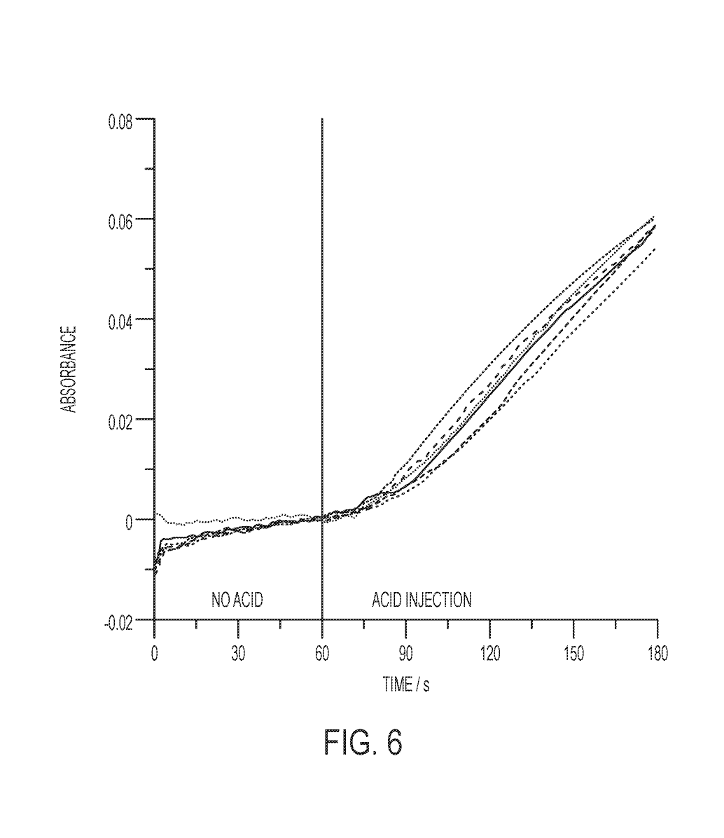

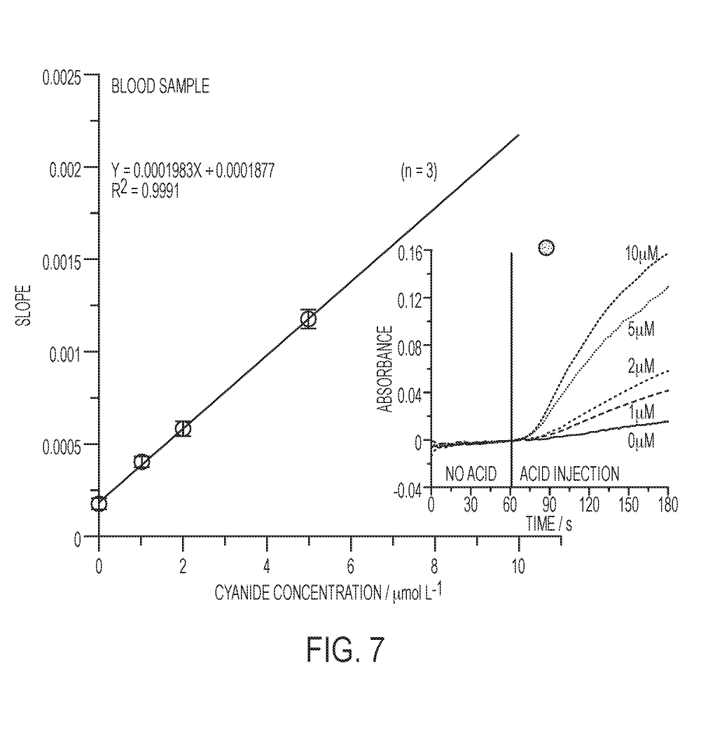

Using 30% (v/v) of H₃PO₄ to release cyanide from the samples, 20 μM of cobinamide solution in 0.01M of borate buffer (pH=10) as cyanide absorbent and colorimetric vehicle, the relative standard deviations (RSD) and limit of detections (LOD) of blood sample and water sample were calculated. Seven determinations of 2 μM cyanide in bovine blood are shown in FIG. 6, accounting the slope of 100s to 160s, the received RSD is 3.6% for the seven determinations. The bovine blood spiked with 0 to 10 μM cyanide was detected by this cyanide detector and the results are shown in FIG. 7. Limit of detection was 0.15 μM (3*S.D._{blank}/k, n=7), linear range was from 0.5 μM to 5 μM and the determination coefficient was (R²) 0.9991 for cyanide detection in 1 mL of bovine blood sample.

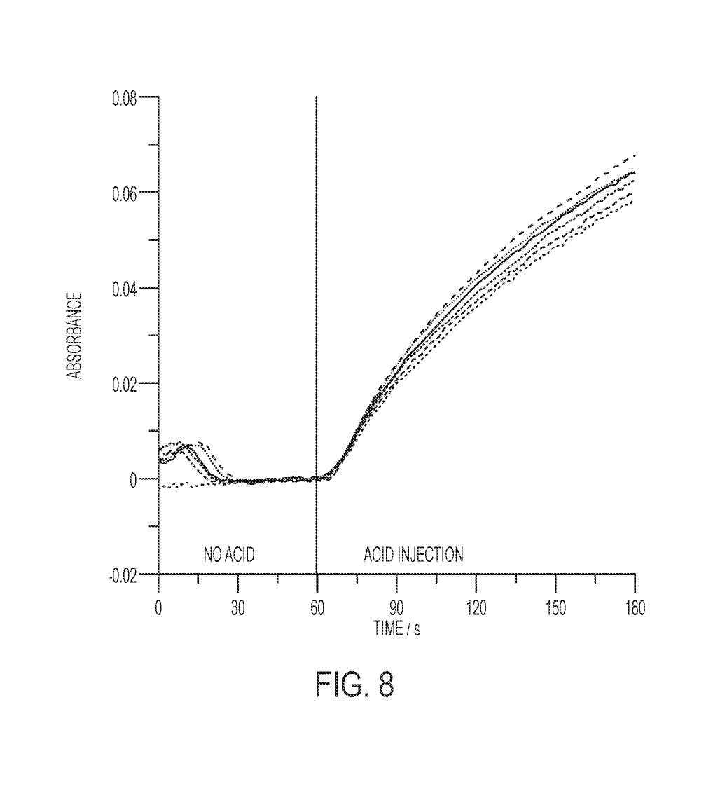

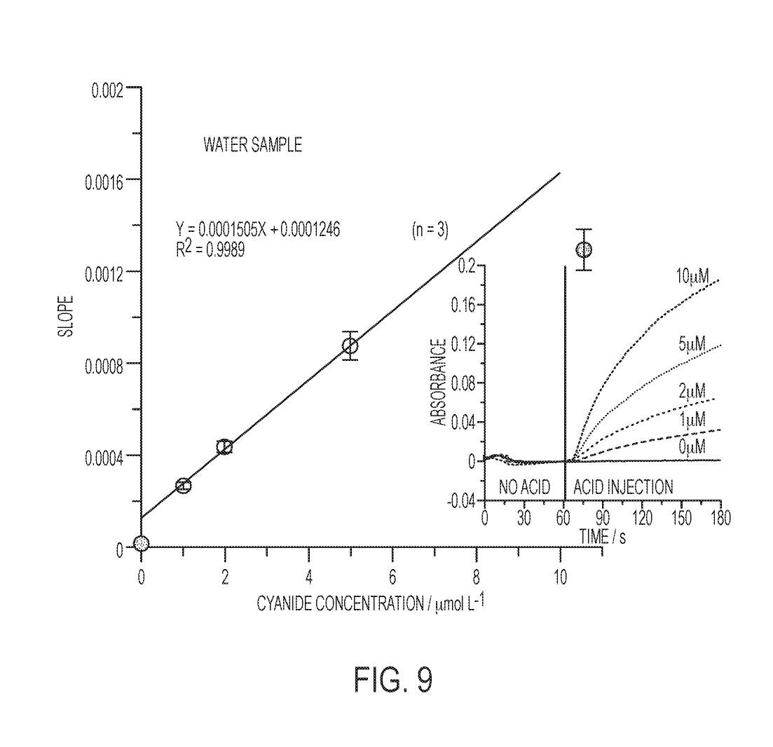

Cyanide in water samples was also analyzed as shown in FIG. 8. 2 μM cyanide in water sample was determined seven times. RSD value was 4.7% (n=7, 2 μM of cyanide). FIG. 9 shows the determination of 0 to 10 μM cyanide in 1 mL water samples. The determined LOD was 0.047 μM, the linear range was 0.15 μM to 5 μM and the determination coefficient (R²) was 0.9989.

In one aspect, the platform 10 of the present application can be used as an inexpensive, portable device for measuring cyanide in breath.

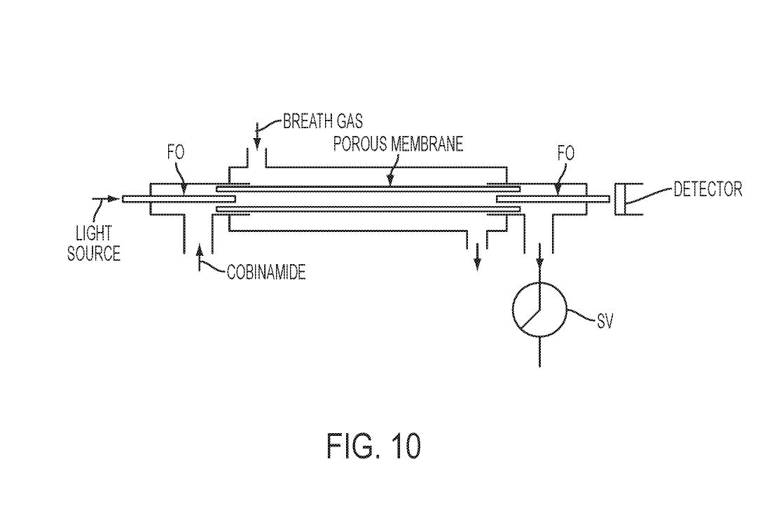

Porous membrane tubes are alternatives to Teflon AF based liquid core waveguides (LCW's) and can be superior for choromogenic gas measurement applications. FIG. 10 illustrates a porous-membrane-based device for measuring cyanide in breath. SV is a shut-off valve; when opened, fresh cobinamide fills the membrane. Light from an LED is transmitted to a photodiode detector by optical fibers (OF). Exhaled air enters the chamber, and cyanide gas in the breath diffuses through the porous membrane, reacting with the cobinamide and the absorbance change is monitored.

To generate HCN gas for calibration potassium cyanide is added to sulfuric acid. After establishing the temperature dependent equilibrium of gaseous HCN over a wide pH and temperature range, the concentration of cyanide gas in the generating system is determined by collecting the gas in alkali and measuring the cyanide in the PPMT based analyzer described above.

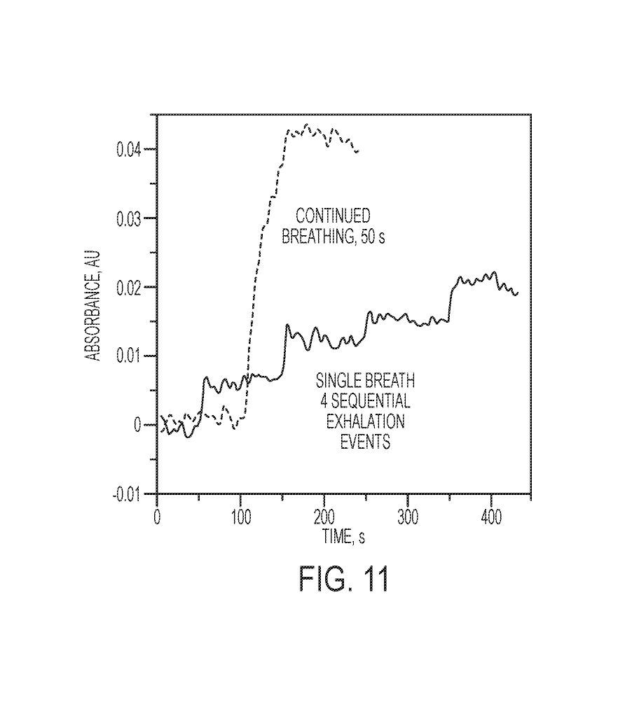

Using the porous-membrane-based device, breath HCN concentrations in three non-smoking subjects were measured. The measurements ranged from ˜3 parts per billion by volume (ppbv) to 35.4±1.4 ppbv. These values fall within the 0-62 ppbv range reported in the literature for non-smoking subjects. In one of the subjects, we measured breath cyanide concentrations on four separate days, and found the following values: 24.4±2.6, 16.3±1.2, 28.0±0.5, 31.0±0.5, and 29.1±0.9 ppbv (mean±SD of three measurements). Thus, although day-to-day variability exists, it is relatively small. FIG. 11 illustrates measurement of breath cyanide in a non-smoking subject either as four separate exhalations or by continuous exhalation over 50 sec.

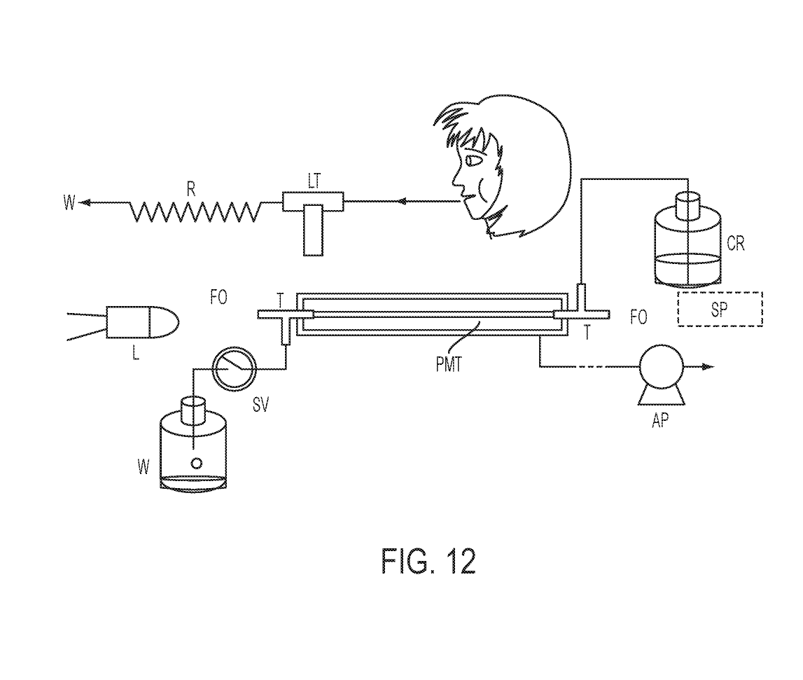

FIG. 12 illustrates a porous membrane-based device in more detail. The subject exhales through the large tee LT and modest restrictor R to vent W. When the sampling sequence is initiated by pressing a button, air pump AP draws a portion of the breath sample through the device. Needle restrictor N acts as a critical orifice and holds the flow rate constant. The pump automatically shuts off after 10 seconds. Porous membrane tube PMT is filled by opening solenoid valve SV with fresh cobinamide reagent CR via tees T, with old reagent going to waste W. The tees accommodate acrylate fiber optics FO connected respectively to one or more different wavelength light emitting diodes L that are alternately pulsed and read at the other end by a signal photodiode SP. Data collection and processing electronics (not shown in this schematic) calculate the slope of the absorbance rise with time, and, based on a calibration plot stored in memory, digitally displays the cyanide concentration and stores it with date and time.

As discussed above, the platform 10 can be used for analysis of at least one volatile analyte (or analyte that can be selectively converted into a volatile form) such as cyanide, ammonia, arsenic, sulfite, sulfide, nitrate (reduced to ammonia), nitrite, hydrazine, hypochlorite (and other species capable of liberating chlorine), iodide and bromide (through formation of iodine and bromine) and the like. For example, available ammonia in a soil sample can be measured by adding a strong base and measuring the liberated ammonia with an acid-base indicator or a selective reagent like Nessler's reagent; nitrate nitrogen (along with ammonium) can be measured by adding powdered Devarda's alloy to the sample prior to adding strong base to produce ammonia from nitrate, acid can be added to liberate nitrous acid from samples containing nitrite for the nitrous acid to subsequently be absorbed by and chromogenically react with Griess-Saltzman reagent, sulfite in food products and wine can be measured by adding acid and liberating sulfur dioxide and absorbing the reacting the same with a solution of permanganate or triiodide to follow loss of color, carbon dioxide/bicarbonate/carbonate in blood can be measured by adding acid and detecting the liberated CO₂ by Phenol red, available chlorine (such as in samples containing chlorite or hypochlorite) or bromine can be measured by adding acid liberating chlorine and detecting the same with DPD (N,N-diphenyl-ρ-phenylene diamine) or more selectively by the bleaching of methyl orange, iodine can be liberated by an oxidant in acidic media and detecting the same with amylose/amylopectin, sulfide can be detected by adding acid to liberate H₂S and absorbing it in a solution of sodium nitroprusside in a chromogenic reaction, arsenic in water can be reduced to arsine by acidification followed by the addition of sodium borohydride to liberate arsine which causes loss of color in a solution of permanganate or triiodide, and so on.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A sensor platform for analyzing an analyte, the sensor platform comprising;
a housing defining an interior chamber configured to hold the analyte therein, the housing having at least a first port and a second port configured to provide access to the interior chamber;
at least one source configured to provide a physical element that can be sensed, wherein at least a portion of the at least one source is positioned therein the first port;
at least one sensor configured to sense the physical element, wherein at least a portion of the at least one sensor is positioned therein the second port; and
a tube positioned in the interior chamber having a first end coupled to a portion of the at least one source, a second end coupled to a portion of the at least one sensor, and defining an inner lumen configured to position a reagent therein, wherein at least a portion of the tube is configured to allow the analyte to pass through an outer wall of the tube and into the inner lumen at a predetermined rate,
wherein the sensor senses a difference in the inner lumen of the tube from a first measurement, in which the reagent is present, to a second measurement, in which the reagent and the analyte are present.

2. The sensor platform of claim 1, wherein the sensor platform is a disposable platform.

3. The sensor platform of claim 1, wherein the sensor platform is a reusable platform

4. The sensor platform of claim 1, wherein the housing comprises a bottom, at least one sidewall, and a sealing cover.

5. The sensor platform of claim 4, further comprising a sample container positioned therein the inner chamber of the housing to hold the analyte therein, wherein the sample container comprises a container bottom and at least one container sidewall extending therefrom.

6. The sensor platform of claim 5, wherein an upper edge of the sidewall of the housing and an upper edge of the sidewall of the sample container are substantially coplanar.

7. The sensor platform of claim 1, wherein a source passageway is defined in a portion of the source, wherein the source passageway is configured so that a fluid entering the source passageway through a side of the source can travel through at least a portion of the source and exit the source through a terminal end of the source.

8. The sensor platform of claim 7, wherein the source passageway is substantially linear.

9. The sensor platform of claim 7, wherein the source passageway is substantially “L-shaped.”

10. The sensor platform of claim 7, wherein a sensor passageway is defined in a portion of the sensor, wherein the sensor passageway is configured so that a fluid entering the sensor passageway through a side of the sensor can travel through at least a portion of the sensor and exit the sensor through a distal end of the sensor.

11. The sensor platform of claim 10, wherein the sensor passageway is substantially linear.

12. The sensor platform of claim 10, wherein the source passageway, the inner lumen, and the sensor passageway are in fluid communication.

13. The sensor platform of claim 1, wherein a portion of the tube is porous, and at least one portion of the tube is impervious.

14. The sensor platform of claim 13, wherein a central portion of the tube is an active portion that is porous, and wherein a first end and a second end of the tube is impervious.

15. The sensor platform of claim 1, wherein a diameter of the inner lumen is selected to minimize preconcentration of the reagent and the analyte in the inner lumen, and to maximize source throughput through the tube.

16. The sensor platform of claim 1, further comprising a heater positioned adjacent to a portion of the chamber configured to heat the contents of the chamber a predetermined amount.

17. The sensor platform of claim 1, wherein the reagent is pre-loaded into the chamber of the housing prior to use by a user of the platform.

18. The sensor platform of claim 1, wherein the reagent is a solid reagent affixed to a portion of the sample container.

19. A method of producing the sensor platform of claim 1.

20. A method for analyzing an analyte comprising:
providing a sensor platform comprising:
a housing defining an interior chamber configured to hold the analyte therein, the housing having at least a first port and a second port configured to provide access to the interior chamber;
at least one source configured to provide a physical element that can be sensed, wherein at least a portion of the at least one source is positioned therein the first port;
at least one sensor configured to sense the physical element, wherein at least a portion of the at least one sensor is positioned therein the second port; and
a tube positioned in the interior chamber having a first end coupled to the first port, a second end coupled to the second port, and defining an inner lumen configured to position the reagent therein, wherein at least a portion of the tube is configured to allow the analyte to pass through an outer wall of the tube and into the inner lumen at a predetermined rate;
placing a sample of the analyte into the interior chamber;
inserting a first reagent through the first port of the housing and into the inner lumen of the tube;
determining a first concentration of reagent in the inner lumen by sensing an amount of the reagent absorbed by the source;
waiting a predetermined amount of time for a portion of the analyte to pass through an outer wall of the tube and into the inner lumen;
determining a second concentration of reagent and analyte in the inner lumen by sensing an amount of the reagent and analyte absorbed by the source; and
comparing the first concentration to the second concentration.
